(19) United States
(12) Patent Application Publication
(10) Pub. No.: US 2024/0196814 A1
(43) Pub. Date: Jun. 20, 2024

(54) FUNGUS BED CULTIVATION BAG AND METHOD FOR PRODUCING FUNGUS BED CULTIVATION BAG

(71) Applicant: F.TEC CO.,LTD., Nobeoka-shi, Miyazaki (JP)

(72) Inventors: Kenichirou SHIRAHANE, Nobeoka-shi, Miyazaki (JP); Osamu TOMOI, Nobeoka-shi, Miyazaki (JP)

(21) Appl. No.: 18/580,285

(22) PCT Filed: Apr. 8, 2022
(86) PCT No.: PCT/JP2022/017340

§ 371 Date: Jan. 18, 2024

(30) Foreign Application Priority Data
May 20, 2021 (JP) 2021-085673

(51) Int. Cl. A01G 18/00; B31B 70/26; B31B 70/64; B31B 160/20; B65D 30/20

(52) U.S. Cl. CPC A01G 18/00; B31B 70/266; B31B 70/64; B65D 31/10; B31B 2160/20

(57) ABSTRACT

To provide a fungus bed cultivation bag that prevents mushroom spawn film from tearing when the fungus bed is removed from the bag and can surely form the fungus bed in an appropriate shape. The fungus bed cultivation bag includes body parts opposing in the front and the back, a folding gusset part connecting to both sides of the body parts, a bottom seal part formed by heat-sealing the lower ends of the body parts and an inclined seal part formed by heat-sealing the lower end sides of the body parts and the folding gusset part in an oblique direction.

### CROSS REFERENCE TO RELATED APPLICATION

This application is a national stage application of International Patent Application No. PCT/JP2022/017340, filed on Apr. 8, 2022, which claims the priority of Japan Patent Application No. 2021-085673 entitled “FUNGUS BED CULTIVATION BAG AND METHOD FOR PRODUCING FUNGUS BED CULTIVATION BAG” filed with the Japan Patent Office on May 20, 2021, which is incorporated herein by reference in its entirety.

### TECHNICAL FIELD

The present disclosure relates to a fungus bed cultivation bag used for artificially cultivating a mushroom such as a shiitake or a maitake and a method for producing the same.

### BACKGROUND ART

In recent years, bags made of plastic film have been increasingly used for artificial cultivation of mushrooms.

In the artificial cultivation of mushrooms by using these types of fungus bed cultivation bags, an artificial medium (fungus bed) is first prepared by mixing wood base materials such as wood chips with a nutritional source such as rice bran and adjusting the moisture content. The fungus bed is then filled in the fungus bed cultivation bag and sterilized with high-pressure steam, etc. Subsequently, mushroom spawn is inoculated onto the fungus bed to proceed with the cultivation process.

During the cultivation process, the mushroom spawn grows on the fungus bed and forms a film on the surface of the fungus bed to prepare for mushroom fruiting.

Since fungus bed cultivation bags are disposable, they should be inexpensive and produced with as simple a configuration as possible.

Furthermore, when cultivating mushroom spawn using fungus bed cultivation bags, fungus bed cultivation bags should supply the necessary air for the growth of the fungi and prevent the intrusion of contaminants.

Additionally, after the cultivation process, artificial cultivation of mushrooms using fungus bed cultivation bags requires a process (mushroom fruiting process) to remove the fungus bed from the fungus bed cultivation bag before mushroom fruiting.

Conventionally, fungus bed cultivation bags designed to meet the above-mentioned requirements have been proposed with the following configurations (refer to Patent Document 1).

As shown in FIG. 8A and FIG. 8B, the fungus bed cultivation bag disclosed in Patent Document 1 includes a bag body 101 made from plastic film formed such that its upper end is open, the bag body being molecularly oriented so that its vertical tensile strength is greater than its horizontal tensile strength, a ventilation hole 105 formed at the upper part of the bag body, and a filter 106 sealed to the bag body covering the ventilation hole to allow air passage while preventing the intrusion of contaminants.

The bag body 2 is formed by gusset-folding both sides of a thin-walled tube formed by inflation process, to form the gusset parts 102 and then by sealing the lower end (103) to form a bag shape. Although not shown in FIG. 8A and FIG. 8B, the fungus bed cultivation bag also includes a tear tab for breaking and tearing the bag body 2.

### DOCUMENT IN THE EXISTING ART

### Patent Document

Patent Document 1: JP2015-8690 A

### SUMMARY

### The Technical Problem Solved by the Disclosure

In the configuration of conventional fungus bed cultivation bags like that in Patent Document 1, as shown in the FIG. 8A and FIG. 8B, when the gusset parts 102 are expanded to fill the fungus bed to form the bag body in an approximate cuboid, the lower end of the gusset parts are folded in a triangular shape to form an overlapping rectangle bottom with the bottom gusset.

In the expanded bag, the part folded in a triangular shape from the lower ends of the gusset parts 102 to the rectangle bottom gusset forms a triangular pocket part 104 inside the bottom of the expanded bag. When the fungus bed is filled inside the bag, wood chips, etc., forming the fungus bed can also enter these triangular pocket parts 104 that communicate with the inside of the bag.

In such cases where wood chips, etc., have entered the pocket parts during the cultivation process, mushroom spawn also extends to these wood chips, etc., within the triangular pockets. Therefore, when the fungus bed is removed from the bag after a film has formed on the fungus bed due to mushroom spawn growth, the spawn that entered these pocket parts peel off to tearing the film formed on the surface of the fungus bed. This adversely affects mushroom production.

Furthermore, since the bag body is made of flexible plastic film in conventional fungus bed cultivation bags, slackness easily occurs between the four corners of the bag body and the fungus bed when the fungus bed cultivation bag is filled with a fungus bed to form the bag body in an approximate cuboid shape.

The slackness in the corners of the bag can lead to wrinkles or inclined bags causing the distorted gravity center of the fungus bed. This poses a problem in ensuring proper shaping of the fungus bed.

The present disclosure was developed to solve the above-mentioned problems. An objective of the present disclosure is to provide a fungus bed cultivation bag and a method of producing the same that prevent mushroom spawn film from tearing when the fungus bed is removed from the bag and can surely form the fungus bed in an appropriate shape.

### Solution for Solving the Technical Problem

To solve the above-mentioned problems, a fungus bed cultivation bag according to the present disclosure, the fungus bed cultivation bag being formed from plastic film, includes: body parts 20, 21 opposing in the front and the back: a folding gusset part 22 connecting to both sides of the body parts: a bottom seal part 23 formed by heat-sealing the lower ends of the body parts 20, 21: and an inclined seal part 27 formed by heat-sealing the lower end sides of the body parts 20, 21 and the folding gusset part 22 in an oblique direction.

Additionally, the inclined seal part 27 may be formed at a predetermined inclination angle θ direction near an intersection part (28) between the bottom seal part 23 and a folding valley part 24 of the folding gusset part 22.

Moreover, a method for producing a fungus bed cultivation bag according to the present disclosure includes the steps of: sandwiching an intermediate member 7 between folding gusset parts 22 of a plastic film bag body (2b), the folding gusset parts 22 being connected to body parts 20, 21 opposing in the front and the back, the plastic film bag body (2b) being closed at the lower end by a bottom seal part 23: forming an inclined seal part 27 by heat-sealing the lower end sides of the body parts 20, 21 and the folding gusset parts 22 sandwiching the intermediate member 7 in an oblique direction (S2); and removing the intermediate member 7 from between the folding gusset parts 22 (S3).

The intermediate member 7 may use a laminated plate including a plate-shaped core material 71; an elastic layer 72 formed by laminating an elastic material on both sides of the plate-shaped core material 71: and an adhesion prevention layer 73 laminated on the outer side of the elastic layer 72 to prevent adhesion to the folding gusset part 22 of the bag body 2b due to heat.

### TECHNICAL EFFECT

According to the present disclosure, the overlapping triangular parts formed at the inner bottom part of the bag body having a gusset part on both sides are closed off by an inclined sealing part, thus surely preventing the medium from entering these triangular parts and surely forming the fungus bed in an appropriate cuboid shape at the same time. As the result, the entire mushroom cultivation process including the formation of the medium, the cultivation in the medium, the removal of the medium from the bag, and the mushroom fruiting can be performed satisfactorily.

### BRIEF DESCRIPTION OF THE DRAWINGS

FIG. 1 is a front view showing the configuration of a fungus bed cultivation bag according to one embodiment of the present disclosure.

FIG. 2 is a perspective view of the fungus bed cultivation bag shows in FIG. 1 expanded in an approximate cuboid shape.

FIG. 3 is a bottom view of the fungus bed cultivation bag shown in FIG. 2.

FIG. 4 is a perspective view showing the state of cultivating mushroom spawn by using the fungus bed cultivation bag shown in FIG. 1.

FIG. 5A, FIG. 5B and FIG. 5C show front views illustrating an example inclined sealing part of the fungus bed cultivation bag shown in FIG. 1.

FIG. 6A, FIG. 6B and FIG. 6C show diagrams explaining the overview of each step in the method for producing a fungus bed cultivation bag according to one embodiment of the present disclosure.

FIG. 7 is an enlarged sectional view of an example intermediate member used in the method for producing the fungus bed cultivation bag shown in FIG. 6A, FIG. 6B and FIG. 6C.

FIG. 8A shows a front view showing the configuration of a conventional fungus bed cultivation bag and FIG. 8B shows a perspective view explaining the state of this conventional fungus bed cultivation bag being expanded.

List of reference numerals: 1 fungus bed cultivation bag: 2 bag body: 20 body part: 21 body part: 22 folding gusset part: 23 bottom seal part: 27 inclined seal part: 7 intermediate member: 71 plate-shaped core material: 72 elastic layer; and 73 adhesion prevention layer.

### DETAILED DESCRIPTION OF THE EMBODIMENTS

Hereinafter, the present disclosure will be described more specifically by using preferred embodiments. However, the following embodiments are merely example embodiments of the present disclosure and are not intended to limit the present disclosure.

### Configuration of Fungus Bed Cultivation Bag

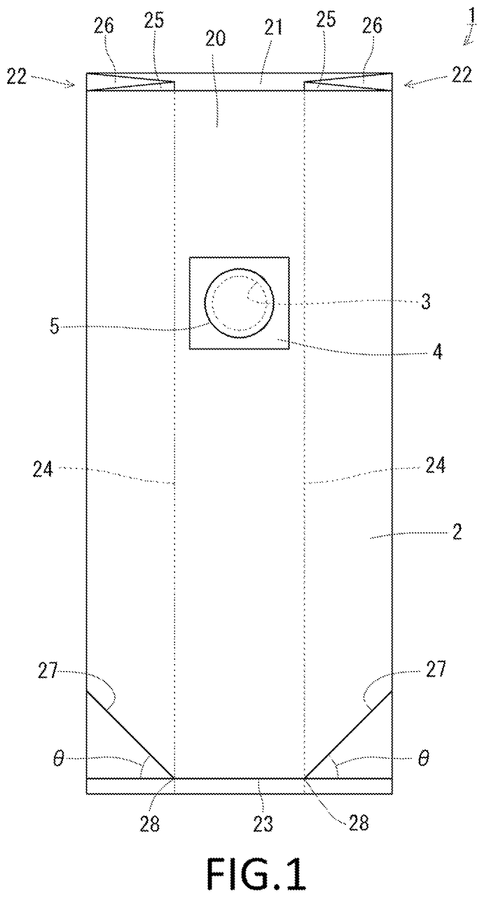

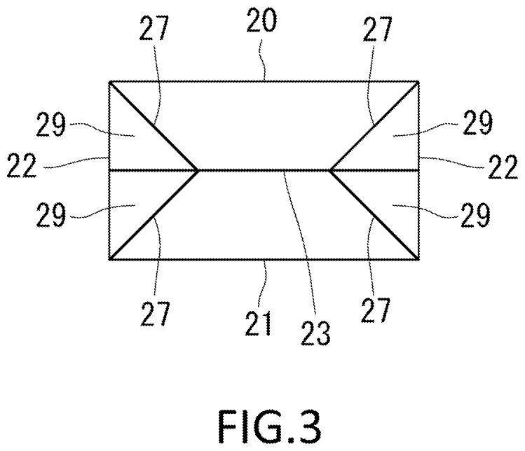

First, the configuration of a fungus bed cultivation bag according to one embodiment of the present disclosure will be described with reference to FIGS. 1 to 5.

As shown in FIG. 1, the fungus bed cultivation bag 1 according to this embodiment includes, for example, a bag body 2 made of a plastic film with an open upper end, a ventilation hole 3 formed in the upper part of the bag body 2, and a filter 4 sealed to the bag body 2 covering the ventilation hole 3 to allow air to pass while preventing the invasion of contaminants.

The fungus bed cultivation bag 1 may be provided with a tear tab, perforations, etc., for breaking and tearing the bag body 2 to remove the fungus bed from the bag body.

The bag body 2 is, for example, formed by gusset folding both sides of a thin-walled tube formed by inflation processing and sealing the lower end by heat-sealing to create a bag shape.

The bag body 2 formed as described above is formed in an open-top bag shape, including body parts 20, 21 opposing in the front and the back, V-shaped folding gusset parts 22 connecting to both sides of the body parts 20 and 21, and a bottom seal part 23 formed by heat-sealing the lower ends of the body parts 20, 21 at the front and the back and the gusset parts 22 at the both sides. For explanatory purposes, the seal parts are shown with thick lines in FIGS. 1, 3, 5, and 6.

The body parts 20 and 21 are formed, for example, in a vertically elongated rectangular shape. When the bag body 2 is expanded, the lower end side bends to form a bottom gusset in a rectangle bottom shape. The folding gusset part 22, which is folded in a V-shape from both the right and left side edges of the body part 20 overlapping at the front and the back, is integrally formed.

Therefore, the folding gusset part 22 has a first gusset piece 25 connected to both side edges of a first (front) body part 20 and a second gusset piece 26 connected to both side edges of a second (back) body part 21 with a folded valley part 24 serving as a folding line.

The bottom seal part 23 is formed by heat-sealing in a straight line along the lower ends of the body parts in a state in which the first and second gusset pieces 25 and 26 of the folding gusset part 22 are overlapping the lower end sides of the front and the back body parts 20, 21.

Furthermore, on the lower side of the bag body 2, an inclined seal part 27 is formed by heat-sealing in an inclined direction relative to the bottom seal part 23.

The inclined seal part 27 is formed by heat-sealing the lower end sides of the body parts 20 and 21 in an oblique direction and folding gusset parts 22 in the right and left sides of the body parts, creating a ‘v’ shape when viewed from the front. More specifically, an inclined seal part 27 is formed by heat-sealing the lower end of the first body part 20 and the first gusset pieces 25 on both sides in a straight line of an oblique direction relative to the bottom seal part 23. In the same way, an inclined seal part 27 is formed by heat-sealing the lower end of the second body part 20 and the second gusset pieces 26 on both sides in a straight line of an oblique direction relative to the bottom seal part 23.

The inclined seal part 27 is formed at a predetermined inclination angle θ 0 starting from near the intersection part 28 where the bottom seal part 23 crosses with the folded valley part 24 of the folding gusset part 22.

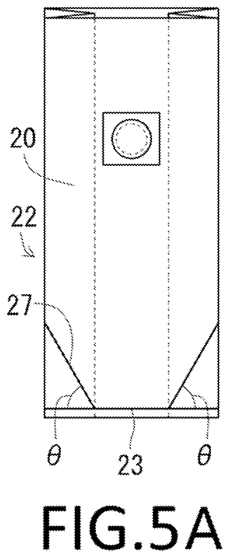

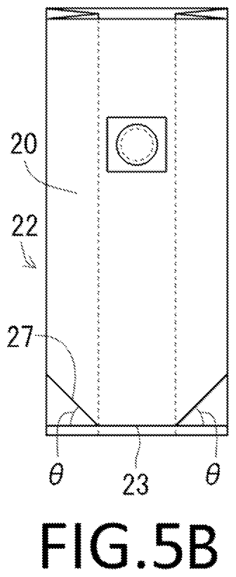

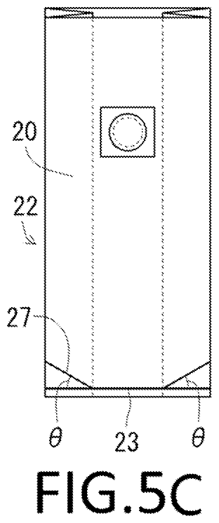

In this embodiment, for example, the inclination angle θ of the inclined seal part 27 is set at about 45 degrees relative to the bottom seal part 23. The inclination angle θ of the inclined seal part 27 may be set at any degree according to the size of the bag body, the folding gusset part, etc., preferably set within a range of about 30 to 60 degrees. FIG. 5A, FIG. 5B and FIG. 5C show examples where the inclination angle θ of the inclined seal part is changed. FIG. 5A, FIG. 5B and FIG. 5C show examples set at an inclination angle θ of 60, 45, and 30 degrees, respectively.

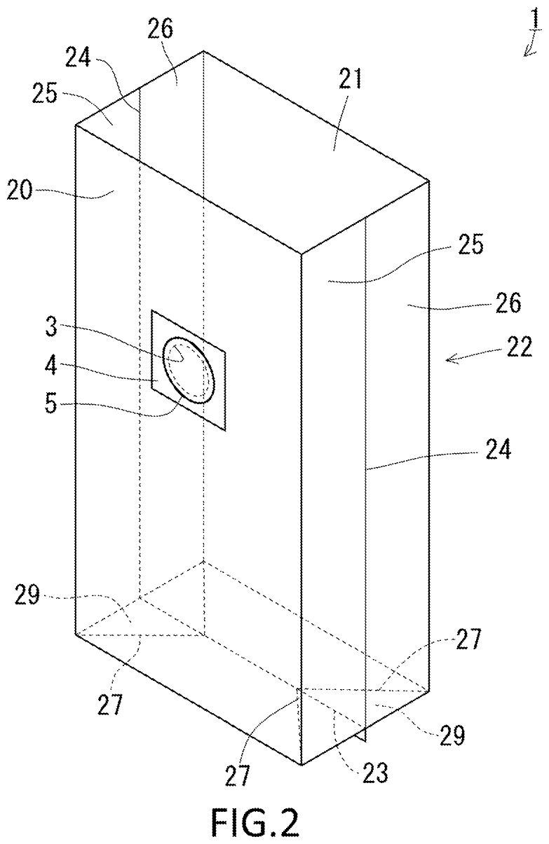

By forming the inclined seal part 27 on the bag body 2 as described above, the bag body 2 can be expanded in an approximate cuboid shape when the bag body 2 is filled with an artificial medium (fungus bed 6), the moisture content of which is adjusted by mixing a nutrient source such as rice bran with woody base materials such as wood chips, as shown in FIGS. 2, 3, and 4. In the state in which the lower end of the folding gusset part 22 is being folded in a triangular shape to form a rectangular bottom, the pocket parts overlapping in a triangular shape will be closed by the inclined seal part 27.

Therefore, when the bag is filled with a fungus bed of wood chips, etc., the fungus bed can be surely prevented from entering the overlapping triangular part 29. As the result, since the mushroom spawn does not extend to unnecessary areas, the film formed on the surface of the fungus bed can be prevent from being damaged when removing the fungus bed from the bag body.

Furthermore, the bag body 2 forms a rectangular bottom to allow the ends of the inclined seal part 27 to reinforce the area around the four corners of the rectangular bottom, which almost eliminates slackness around the four corners of the shaped bag body 2. This surely prevents the shape of the fungus bed from inclining to properly form the fungus bed in an appropriate cuboid shape.

As the result, the cultivation process and subsequent processes of removal of the fungus bed from the bag body and mushroom fruiting.

As the material of the bag body 2, a polyolefin material such as polypropylene or high-density polyethylene or a polyester material is preferable, which is inexpensive and can withstand sterilization by high-pressure steam.

Furthermore, the bag body 2 is preferably transparent or semi-transparent so that the cultivation state of the mushroom spawn can be observed.

In this embodiment, the filter 4 is formed in a rectangular shape. However, the shape of the filter is not limited to rectangles and may be any shape such as a polygon like a pentagon, a circle, or an ellipse.

The filter 4 does not need to completely prevent the invasion of contaminants but only needs to prevent the invasion to the extent without negatively affecting the growth of the mushroom spawn. The filter 4 should be able to withstand sterilization by high-pressure steam and be hermetically sealed to the material of the bag body 2. For example, commercially available porous plastic filters or non-woven fabric filters can be used.

As shown in FIG. 1, the filter 4 is placed over the ventilation hole 3 and then sealed to the bag body 2. In FIG. 1, the reference numeral 5 indicates the sealed part. The filter 4 is placed on the upper part of the bag body 2, preferably at a position that does not get folded when the upper end opening of the bag body 2 is bent to avoid contamination by contaminants.

### Method of Using Fungus Bed Cultivation Bag

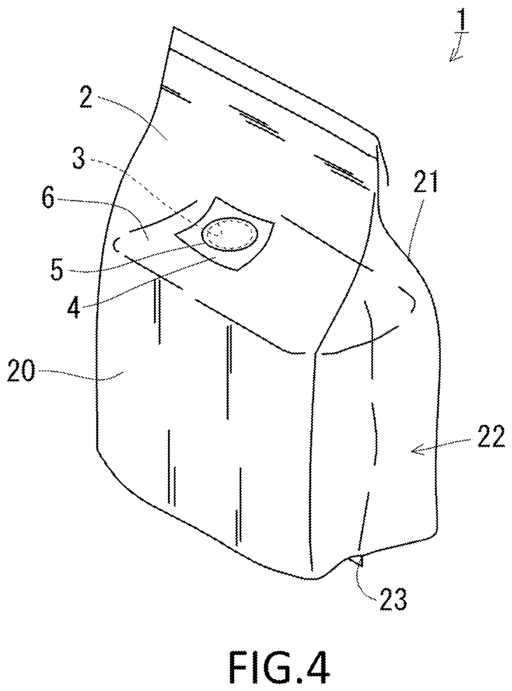

Next, the method of using the fungus bed cultivation bag according to one embodiment of the present disclosure will be explained with reference to FIG. 4.

As shown in FIG. 4, when mushrooms are artificially cultivated, an artificial medium (fungus bed 6) prepared by mixing a nutrient source such as rice bran with woody base materials such as wood chips and adjusting the moisture content is first filled in the bag body 2 of the fungus bed cultivation bag 1 and then sterilized with high-pressure steam at approximately 120° C. for about 2 hours.

Next, mushroom spawn is inoculated in the sterilized fungus bed 6, and the upper end opening of the bag body 2 is closed by heat-sealing. Then, the fungus bed 6 inoculated with the mushroom spawn is stored in a cultivation room at a temperature of about 24° C. and a humidity of about 60% for 30 to 90 days while being filled in the bag body 2 of the fungus bed cultivation bag 1 (cultivation process).

Once the spawn has almost spread throughout the fungus bed 6 (once the cultivation process is completed), the fungus bed 6 is removed from the bag body 2 from the fungus bed cultivation bag 1, and mushrooms (fruiting bodies) are generated in an environment of a temperature of about 18° C. and a humidity of about 90% (mushroom (fruiting body) generation process).

The mushrooms that have emerged from the fungus bed have grown to a certain extent are harvested as appropriate.

### Method for Producing Fungus Bed Cultivation Bag

Next, one embodiment of the method for producing a fungus bed cultivation bag 1 according to the embodiment will be explained below. The same reference numerals are used to describe the same components described above.

First, a bag body 2b with an open top end, folding gusset parts 22 formed on both sides, and a lower end closed by heat-sealing is prepared. Specifically, in the bag body 2b, folding gusset parts 22 are connected to both the left and right sides of the front and back body parts 20 and 21, and a bottom seal part 23 is formed by heat sealing the lower ends in a straight line. The bag body 2b may be either pre-produced or purchased.

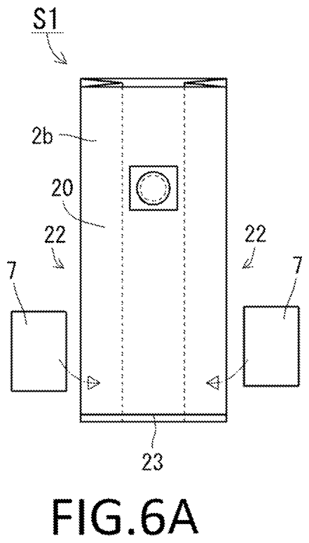

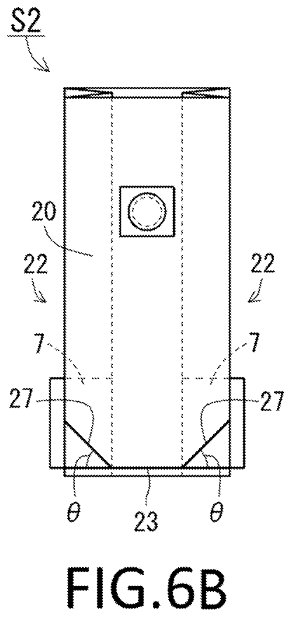

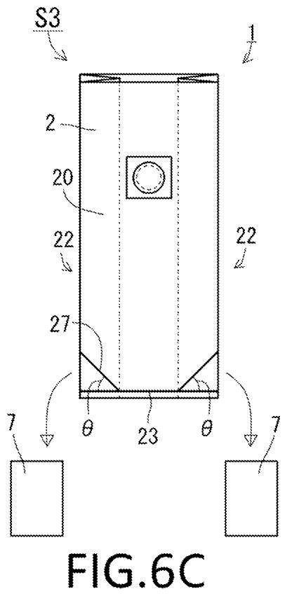

In the first step S1, as shown in FIG. 6A, an intermediate member 7 is sandwiched between the folding gusset parts 22 formed on both sides of the bag body 2b, that is, between the first gusset piece 25 and the second gusset piece 26 and inserted deep in the folded valley part 25.

The intermediate member 7 is a sealing prevention means that is sandwiched in the middle to prevent the first gusset piece 25 and the second gusset piece 26 from being heat-sealed together when an inclined seal part 27 is formed by heat-sealing the first body part 20 with the first gusset piece 25 and the second body part 21 with the second gusset piece 26.

The intermediate member 7 is made of a thin plate-shaped or sheet-shaped member, the surface of which is treated to prevent the intermediate member 7 from adhering to the folding gusset part 22 due to heat during the process of forming the inclined seal part 27.

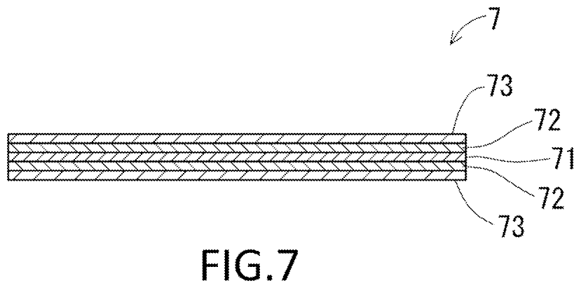

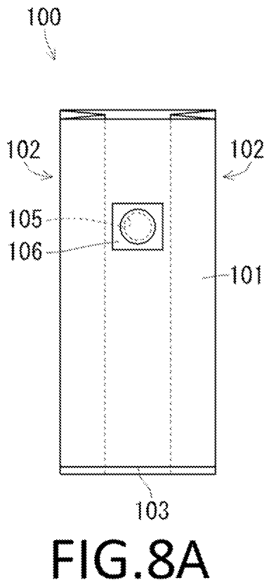

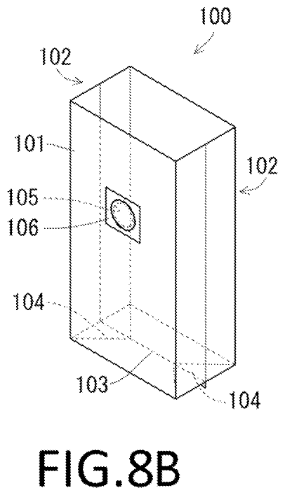

In this embodiment, as shown in FIG. 7, the intermediate member 7 consists of, for example, a laminated plate with a five-layer structure having a plate-shaped core material 71, elastic layers 72 laminated on both surfaces of the plate-shaped core material 71, and adhesion prevention layers 73 laminated on the outer surfaces of each of the elastic layers 72.

The plate-shaped core material 71 of the intermediate member 7 is made of metal such as an iron plate, for example, to provide a certain degree of strength to the entire structure of the intermediate member.

The elastic layer 72 is preferably made of an elastic material such as silicone rubber that is strong against heat and can transmit pressure during heat-sealing to the bag body 2b. In this embodiment, sheet-shaped silicone rubber is adhered to both surfaces of the plate-shaped core material made of an iron plate by using an adhesive, etc.

The adhesion prevention layer 73 is preferably made of a material such as fluororesin that is strong against heat and can prevent adhesion. In this embodiment, fluororesin formed in a sheet shape is adhered to the surface of the elastic layer 71 by using an adhesive, etc.

The intermediate member 7 may be a single-layer structure made of a material such as silicone rubber or fluororesin or may be a three-layer structure with fluororesin, etc., laminated on the surface of silicone rubber.

The intermediate member 7 only needs to be sized to be sandwiched at least within the range where the inclined seal part 27 is formed. In this embodiment, the intermediate member 7 has a vertical width slightly larger than that of the inclined seal part and a horizontal width slightly larger than that of the inclined seal part, that is, slightly larger than the horizontal width of the first gusset piece (second gusset piece) of the folding gusset part 22.

In the next step S2, as shown in FIG. 6B, while the intermediate member 7 is being sandwiched between the first gusset piece 25 and the second gusset piece 26 of the folding gusset part 22, the lower end side of a first body part 20 and the first gusset piece 25 of the forded gusset part are heat-sealed in an oblique direction, and the lower end side of a second body part 21 and the second gusset piece 26 of the forded gusset part are heat-sealed in an oblique direction to form an inclined seal part 27.

For example, to form the inclined seal part 27 by heat-sealing, a brass heat source is set to about 250° C. and pressed against the outer surface side of the plastic film forming body parts 20, 21 for about 0.75 seconds to heat-seal.

In the next step S3, as shown in FIG. 6C, the intermediate member 7 is removed from between the folding gusset parts 22.

This makes it possible to form fungus bed cultivation bag 1 of the present disclosure easily and surely. Each step including sandwiching and removing the intermediate member 7 may be mechanically performed.

1. A fungus bed cultivation bag formed from plastic film, comprising:
front and back opposing body parts;
a folding gusset part on each side of the bag connecting to both sides of the front and back body parts;
a bottom seal part formed by heat-sealing lower ends of the front and back body parts; and
an inclined seal part formed by heat-sealing the lower end sides of the front and back body parts and the folding gusset part in an oblique direction.

2. The fungus bed cultivation bag according to claim 1, wherein the inclined seal part is formed at a predetermined inclination angle direction near an intersection part between the bottom seal part and a folding valley part of the folding gusset part.

3. A method for producing a fungus bed cultivation comprising the steps of:
sandwiching an intermediate member between folding gusset parts of a plastic film bag body, the folding gusset parts being connected to body parts opposing in the front and the back, the plastic film bag body being closed at the lower end by a bottom seal part;
forming an inclined seal part by heat-sealing lower end sides of the body parts and the folding gusset parts sandwiching the intermediate member in an oblique direction; and
removing the intermediate member from between the folding gusset parts.

4. The method for producing a fungus bed cultivation bag according to claim 3, wherein the intermediate member uses a laminated plate including:
a plate-shaped core material;
an elastic layer formed by laminating an elastic material on both sides of the plate-shaped core material, and
an adhesion prevention layer laminated on the outer side of the elastic layer to prevent adhesion to the folding gusset part of the bag body due to heat.
